(19) United States
(12) Patent Application Publication
(10) Pub. No.: US 2009/0284789 A1
(43) Pub. Date: Nov. 19, 2009

(54) INFORMATION DISPLAYING AND PRINTING SYSTEM

(76) Inventors: Toshihiko YOSHINARI, Osaka (JP); Takahiro MINAMI, Osaka (JP)

Correspondence Address: BIRCH STEWART KOLASCH & BIRCH, PO BOX 747, FALLS CHURCH, VA, 22040-0747, US

(21) Appl. No.: 12/437,736

(22) Filed: May 8, 2009

(30) Foreign Application Priority Data
May 16, 2008 (JP) 2008-129176

(51) Int. Cl. G06F 3/12

(52) U.S. Cl. 358/1.15

(57) ABSTRACT

An information displaying and printing system that reduces the time to wait for printing of content displayed on a displaying apparatus to complete is provided. An image forming apparatus transmits an image data and an identification information of the image data stored in a registration information database to a displaying apparatus. The displaying apparatus receives an image data and an identification information of the image data, displays the image data, and transmits a print request with the identification information to the image forming apparatus. The image forming apparatus searches for an identification information coinciding with the identification information received from the displaying apparatus by referring to the registration information database, reads the image data from the registration information database, and prints the image data.

### CROSS-NOTING PARAGRAPH

This non-provisional application claims priority under 35 U.S.C. §119(a) on Patent Application No. 2008-129176 filed in JAPAN on May 16, 2008, the entire contents of which are hereby incorporated herein by reference.

### FIELD OF THE INVENTION

The present invention relates to an information displaying and printing system that data-communicably connects an image forming apparatus and a displaying apparatus.

### BACKGROUND OF THE INVENTION

Research and development concerning displaying apparatuses have recently been actively executed and an example of the displaying apparatuses is an electronic paper terminal. The electronic paper terminal may display an image of image data transmitted from an external apparatus. The electronic paper terminal has a characteristic that the terminal is excellent in portability and concurrently has a characteristic of a displaying apparatus that may repeatedly rewrite the content of the display.

For example, Japanese Laid-Open Patent Publication No. 2006-41759 describes a technique that enables, in a simple method, execution of transfer of the content read from an image forming apparatus to an electronic paper terminal, and transmission of the content displayed on the electronic paper terminal to the image forming apparatus and printing of the content.

Recently, a technique of inputting handwritten characters and diagrams and synthesizing them with displayed image data is prevailing. For example, Japanese Laid-Open Patent Publication No. 1998-39844 discloses an electronic message board that accepts handwriting and that may easily and correctly create messages of various contents by synthesizing the handwriting data with an image predetermined.

Generally, when a person reads a document printed on a paper sheet, the person underlines about the portions thereof that the person thinks important and makes notes in handwriting.

Similarly, the person may make notes in handwriting and underline in the document displayed on the electronic paper terminal. However, to print and retain the document added with the notes and underlines, the document needs to be transferred from the electronic paper terminal to an image forming apparatus.

However, when the object to be printed is in colors or when the size of the object displayed is large, the amount of data to be transferred is large and a significant time period is necessary to transfer the image data from the electronic paper terminal to the image forming apparatus.

### SUMMARY OF THE INVENTION

The object of the present invention is to provide an information displaying and printing system that reduces the time to wait for printing of the content displayed on a displaying apparatus to be completed.

An information displaying and printing system of the present invention includes an image forming apparatus and a displaying apparatus connected to the image forming apparatus, wherein

the image forming apparatus includes a registering portion that has an image data and an identification information of the image data stored in a registration information database correlating the image data and the identification information with each other, a transmitting portion that transmits an image data and an identification information of the image data to the displaying apparatus, a receiving portion that receives a print request of an image data from the displaying apparatus, a searching portion that searches the registration information database in response to the print request, and a printing portion that prints the image data of the search result, wherein

the displaying apparatus includes a receiving portion that receives an image data and an identification information of the image data from the image forming apparatus, a registering portion that has the image data and the identification information of the image data received stored in an image data storing portion, and a transmitting portion that transmits the identification information for the image data to be printed, as a print request to the image forming apparatus, and wherein

when a print request is issued from the displaying apparatus, the image forming apparatus refers to the registration information database, searches for an identification information coinciding with the identification information received from the displaying apparatus, reads an image data corresponding to the identification information that coincides from the registration information database, and prints the read image data.

The image data to be printed may be an image data displayed on the displaying apparatus or the image data stored in the image data storing portion.

When the image data and the identification information are transmitted from the image forming apparatus to the displaying apparatus, the image data and the identification information are separately transmitted or are transmitted incorporating the identification information in the header portion of the image data.

The displaying apparatus further includes a memo data adding portion for adding a memo data to the image data stored in the image data storing portion. When the memo data added to the image data is printed together with the image data, the identification information of the image data, position information added with the memo data, and the memo data are transmitted. The image forming apparatus obtains an image data corresponding to the received identification information from the image information database, synthesizes the received memo data with the image data at a position in the image data indicated by the received position information, and prints the resultant image data.

### BRIEF DESCRIPTION OF THE DRAWINGS

FIG. 1 is a pattern diagram of the configuration of an information displaying and printing system according to an embodiment of the present invention;

FIG. 2 is a block diagram of the configuration of an image forming apparatus;

FIG. 3 is a block diagram of the configuration of a displaying apparatus;

FIG. 4 is an explanatory diagram of a registration information database;

FIGS. 5A and 5B are explanatory diagrams of data formats to be transferred from the image forming apparatus to the displaying apparatus;

FIG. 6 is an explanatory diagram of an image data storing portion;

FIGS. 7A and 7B are explanatory diagrams of data formats to be transferred from the displaying apparatus to the image forming apparatus;

FIG. 8 is a flowchart of a process procedure to a step of transmitting image data from the image forming apparatus to the displaying apparatus;

FIG. 9 is a flowchart of a process procedure to a step of transmitting printing instruction from the displaying apparatus to the image forming apparatus;

FIG. 10 is a flowchart of a process procedure to a step of printing by the image forming apparatus of image data for which a print request is issued; and

FIG. 11 is an explanatory diagram of a combining process of image data and memo data.

### PREFERRED EMBODIMENTS OF THE INVENTION

A preferred embodiment according to an information displaying and printing system of the present invention will now be described with reference to the accompanying drawings.

### <Total Configuration of Information Displaying and Printing System>

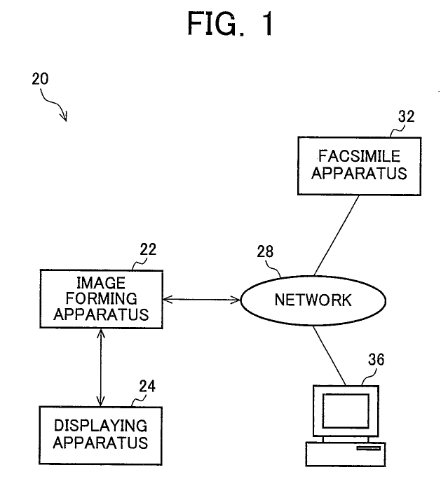

FIG. 1 is a pattern diagram of the configuration of an information displaying and printing system 20 according to an embodiment of the present invention. In FIG. 1, the information displaying and printing system 20 includes an image forming apparatus 22 and a displaying apparatus 24 that are mutually connected through a wired or wireless interface and that may mutually transmit and receive various types of data including image data.

Though the image forming apparatus 22 and the displaying apparatus 24 are mutually connected using a USB (Universal Serial Bus) cable, the connection is not limited to this and the connection may employ short-distance wireless communication such as those using infrared rays or Bluetooth (a registered trademark), or may be wired or wireless network connection.

The image data is not limited only to image data and the image data includes, for example, data that includes document data, and data that includes image data and document data.

The image forming apparatus 22 is connected to a facsimile apparatus 32 and a terminal apparatus 36 such as a PC (Personal Computer) through a network 28.

The network 28 includes one or more of a telephone line network, a LAN (Local Area Network), and the Internet combining these together. Various types of data including image data may be transmitted and received among the image forming apparatus 22, the facsimile apparatus 32, and the terminal apparatus 36.

### <Configuration of Image Forming Apparatus 22>

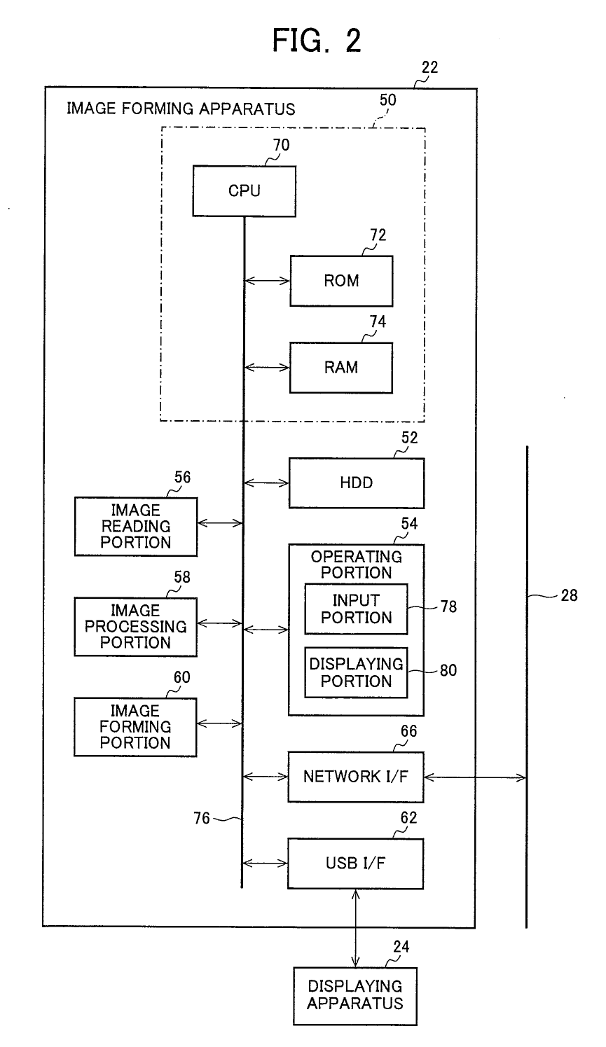

FIG. 2 is a block diagram of the configuration of the image forming apparatus 22. The image forming apparatus 22 of the embodiment will be described as, for example, a digital MFP (Multifunction Printer) that includes a scanner function, a copying function, a facsimile function, and a printer function. However, the image forming apparatus 22 is not limited to this.

In FIG. 2, the image forming apparatus 22 includes an apparatus control portion 50, an HDD (Hard Disc Drive) 52, an operating portion 54, an image reading portion 56, an image processing portion 58, an image forming portion 60, a USB interface (USB I/F) 62, and a network interface (network I/F) 66.

The apparatus control portion 50 substantially is a computer and includes a CPU (Central Processing Unit) 70, a ROM (Read Only Memory) 72, and a RAM (Random Access Memory) 74.

The ROM 72 has stored therein various computer programs, control information, and setting information to control the image forming apparatus 22. The CPU 70 executes the various computer programs in response to instructions from the operating portion 54, etc., and, thereby, processes such as operations of the respective components and communication with external apparatuses such as the displaying apparatus 24, etc., of the image forming apparatus 22 are executed.

The HDD 52 includes a magnetic storage medium and provides a storage area that has stored therein various pieces of data including image data. The HDD 52 has stored therein a registration information database (hereinafter, “registration information DB”) that has stored therein image data read by the image forming apparatus 22.

The operating portion 54 includes an operation panel including an input portion 78 that includes a touch panel having various input keys, etc., and a displaying portion 80 such as a liquid crystal display (hereinafter, “LCD”), stacking those portions therein.

A user properly switches a screen that displays an image of various operating keys displayed on the displaying portion 80 and touches the operating keys on the screen with the input portion 78.

The coordinates of the position on the screen that the user touches are output to the apparatus control portion 50 and, thereby, instructions of the user for operations and various settings of the image forming apparatus 22 are obtained.

The content of an instruction by the user and information to be notified of to the user are displayed on the displaying portion 80 and a control signal corresponding to the instruction is output to the apparatus control portion 50. Thereby, a process corresponding to the input operation of the user may be realized.

The image reading portion 56 forms on a CCD line sensor a reflected image obtained by applying a light beam on the surface of an image of a document mounted on a scanner platen not shown, and the image reading portion 56 sequentially photo-electrically converts the reflected image formed and outputs the image as image data to the apparatus control portion 50.

The image processing portion 58 executes predetermined image processing such as, for example, a gamma correction process and a filtering process to the image data input from the image reading portion 56 or an external apparatus, and the image processing portion 58 causes the HDD 52 to have stored therein the image data applied with the processing.

In response to the instruction from the apparatus control portion 50, etc., the image forming portion 60 forms an image on a recording paper sheet based on the image data sequentially read from the HDD 52.

The USB I/F 62 is an interface including a USB port and supporting Hot Plug and automatically recognizes external apparatuses such as the displaying apparatus 24, etc., electrically connected through a USB cable while the image forming apparatus 22 is operating. Transmission and reception of control information and image data between the image forming apparatus 22 and the displaying apparatus 24 are executed through this USB I/F 62.

The image forming apparatus 22 is connected to the network 28 through the network I/F 66, may facsimile-communicate with the facsimile apparatus 32 that is connected to the network 28, and may data-communicate with the terminal apparatus 36. Image data obtained through the network 28 is output to the apparatus control portion 50.

The CPU 70, the ROM 72, the RAM 74, the HDD 52, the operating portion 54, the image reading portion 56, the image processing portion 58, the image forming portion 60, the USB I/F 62, and the network I/F 66 are electrically connected to a BUS line 76.

### <Configuration of Displaying Apparatus 24>

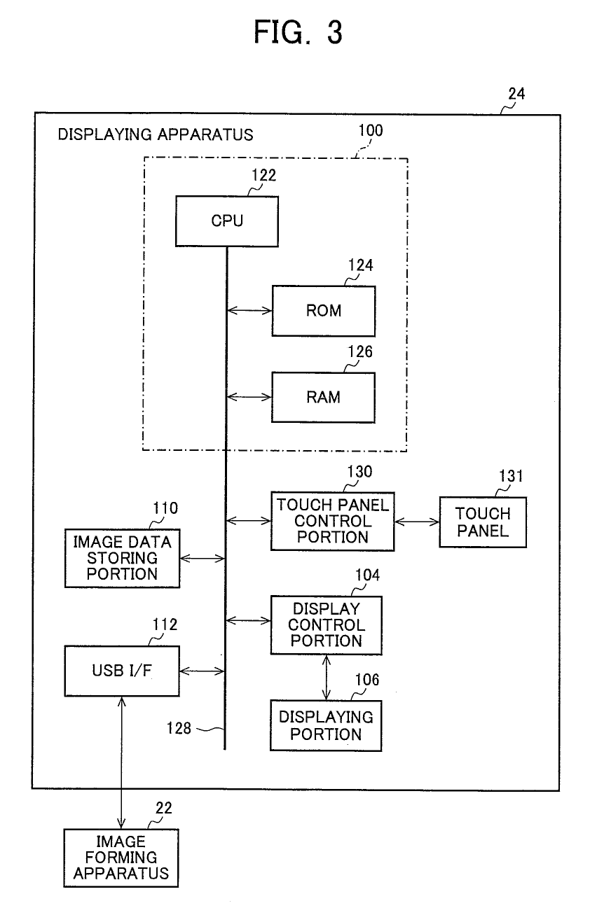

FIG. 3 is a block diagram of the configuration of the displaying apparatus 24. The displaying apparatus 24 of the embodiment will be described as a so-called electronic paper terminal.

In FIG. 3, the displaying apparatus 24 includes a general control portion 100, a display control portion 104, a displaying portion 106, an image data storing portion 110, a USB I/F 112, a touch panel control portion 130, and a touch panel 131.

The general control portion 100 is substantially a computer and includes a CPU 122, a ROM 124, and a RAM 126. The ROM 124 has stored therein various computer programs that control the displaying apparatus 24. The CPU 122 executes the various computer programs in response to instructions from an external apparatus, etc., and, thereby, desired processes such as operations of the components of the displaying apparatus 24 and communication with external apparatuses such as the image forming apparatus 22, etc., are executed.

According to an instruction of the general control portion 100, the display control portion 104 drives the displaying portion 106 and causes the displaying portion 106 to display thereon the image data stored in the image data storing portion 110 or an image of display data as a user interface. The displaying portion 106 is formed in the central portion of the displaying apparatus 24.

The image data storing portion 110 includes a non-volatile memory and has stored therein image data captured from the image forming apparatus 22 through the USB I/F 112. The image data storing portion 110 executes reading or writing of image data in response to an R/W (Read/Write) signal transmitted from the general control portion 100 or the display control portion 104, etc.

The USB I/F 112 is an interface including a USB terminal and supporting Hot Plug and automatically recognizes external apparatuses such as the image forming apparatus 22, etc., connected through a USB cable while the displaying apparatus is operating. Transmission and reception of control information and image data between the displaying apparatus 24 and the image forming apparatus 22 are executed through this USB I/F 112.

The touch panel control portion 130 is connected to a touch panel 131 as a memo input portion. The touch panel 131 is disposed being stacked on the displaying portion 106 and is configured to enable the content of the display of the displaying portion 106 to be viewed therethrough. The touch panel 131 plays a role of input by handwriting image data such as characters or diagrams based on a locus of move on the surface thereof of a finger (or an input pen), etc., as an input instructing object, and the touch panel 131 also functions as a multi-purpose input portion to execute input of various modes and selective input of a regular character group as a regular image. The configuration of the touch panel 131 is known and will not be illustrated. Data input from the touch panel 131 is stored in the image data storing portion 110 as the display position and the data content of the data.

The CPU 122, the ROM 124, the RAM 126, the display control portion 104, the displaying portion 106, the image data storing portion 110, the USB I/F 112, the touch panel control portion 130, and the touch panel 131 are electrically connected to a BUS line 128.

### <Overview of Processing in System 20>

The overview of the processing in the information displaying and printing system 20 will be described.

A user stores image data received from the facsimile apparatus 32, image data received from the terminal apparatus 36, or image data read by the image reading portion, in the HDD (registration information DB) 52 for each page.

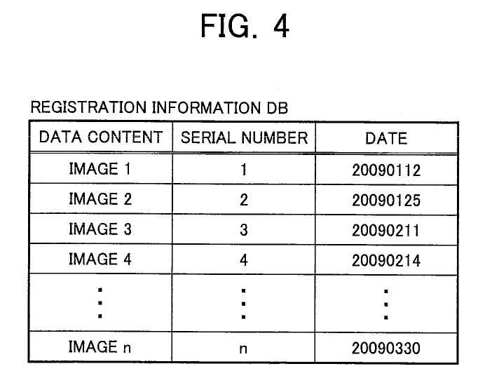

The registration information DB has registered therein the image data (that otherwise may be the name of a file having the image data stored therein) correlating with identification information. The identification information includes a serial number that is the only name in the registration information DB and information on the date and time of registration (FIG. 4).

When the user desires to cause the image data stored in the registration information DB of the image forming apparatus 22 to be displayed on the displaying apparatus 24, the user connects the displaying apparatus 24 to the image forming apparatus 22 with a USB cable.

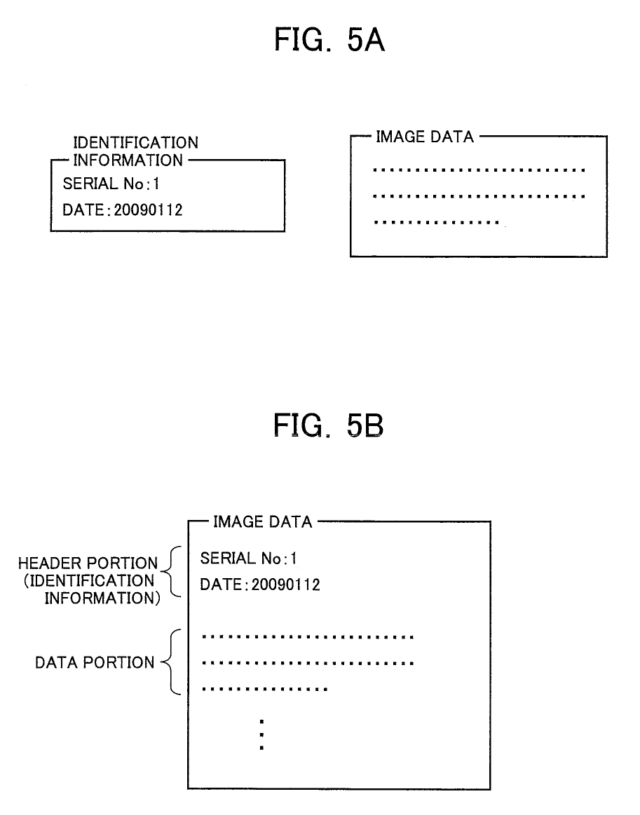

When the image forming apparatus 22 detects the connection to the displaying apparatus 24, the image forming apparatus 22 causes the user to select the user's desired image data from the registration information DB and transfers the image data selected and its identification information to the displaying apparatus 24 for the quantity selected. This transfer may be executed as transmission of the identification information and the image data each separate from each other and as a pair (FIG. 5A) or may be executed as transmission of the image data with the identification information incorporated in the header of the image data (FIG. 5B).

The displaying apparatus 24 causes the image data storing portion 110 to have stored therein the image data and the identification information transferred from the image forming apparatus 22.

The user disconnects the displaying apparatus 24 from the image forming apparatus 22, and causes the displaying apparatus 24 to display the image data stored in the image data storing portion 110 or to execute additional processes of the memo data input by handwriting on the touch panel 131 or using the keys, etc.

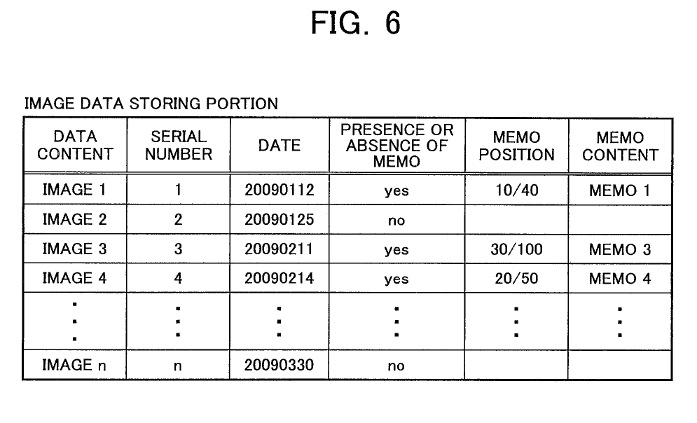

At this time, the image data storing portion 110 has stored therein the following pieces of data correlating these pieces of data with pieces of image data each added with memo data (FIG. 6). When plural pieces of memo data are present, the memo position and the memo content are stored for a plurality of times.

Presence or Absence of Memo: “yes” is stored when one or more pieces of memo data is/are added, and “no” is stored when no memo data is present.

Memo Position: The position on a screen to which the memo data is added is stored. For example, the position is represented by the position in the horizontal direction and the position in the vertical direction on the screen in upper left of the memo.

Memo Content: The content itself of the memo data or the name of the file having stored therein the content of the memo data is stored.

When the user desires to print image data displayed on the displaying apparatus or the image data together with the memo data added to the image data, the user connects the displaying apparatus 24 to the image forming apparatus 22 with the USB cable and issues a printing instruction of the image data that the user desires to print.

The displaying apparatus 24 transfers the identification information and the memo data of the image data for which the printing instruction is issued, to the image forming apparatus 22. This identification information includes the serial number and the information of the date and time to identify the image data, presence or absence of the memo data, and the memo position.

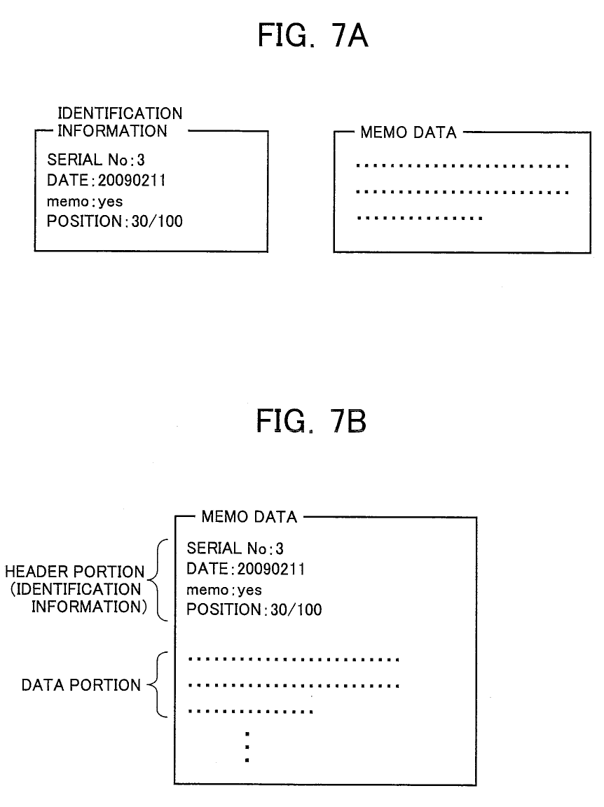

The transfer of the identification information and the memo data may be executed as transmission of the identification information and the memo data each as separate data as a pair (FIG. 7A), or may be executed as transmission of the memo data with the identification information incorporated in the header of the memo data (FIG. 7B).

However, when no memo data is present, the presence or absence of memo (no), and the serial number and the information on the date and time of the image data are transmitted.

The image forming apparatus 22 obtains from the registration information DB the image data corresponding to the identification information including the serial number and the information on the date and time that coincide with these in the identification information received from the displaying apparatus 24 and the image forming apparatus 22 prints the image data. When the memo data is present in the identification information, the memo data is synthesis-processed at the memo position of the image data and is printed.

### <Transferring Process of Image Data in Apparatus Control Portion of Image Forming Apparatus 22>

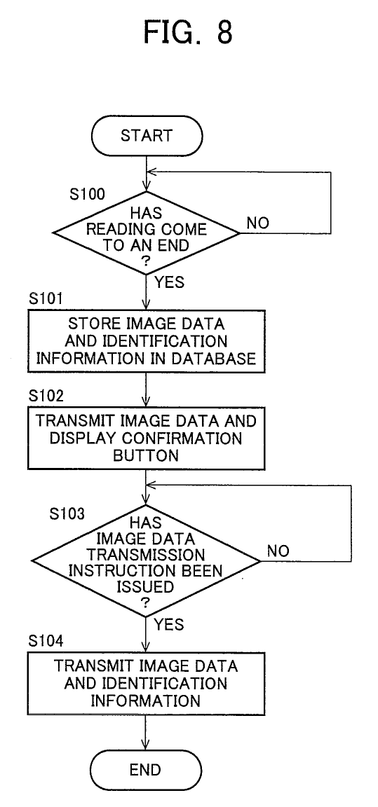

FIG. 8 is a flowchart of a process procedure to a step of transmitting image data from the image forming apparatus 22 to the displaying apparatus 24. In this case, the procedure will be described taking an example of the case where the image forming apparatus 22 and the displaying apparatus 24 are connected with a USB cable, the image data obtained by reading a document in a scanner function of the image forming apparatus 22 is transferred, and the image data is viewed using the displaying apparatus 24.

When the user places the document on the scanner platen and presses a read start button, the image reading portion 56 starts reading the document by the scanner function (step S100), the image reading portion 56 continues step S100 until the reading of the document is completed.

When the reading of the document comes to an end (YES at step S100), the image data read is stored in the HDD 52, and the name of a file and identification information for the storage are registered in the registration information DB being correlated with each other (step S101). The identification information includes a serial number that is the only name and information on the date and time of storing image data. When the document has a plurality of pages, the image data and the identification information are registered in the registration information DB being correlated with each other for each page.

The image forming apparatus 22 displays on the displaying portion 80 a confirmation button for confirming whether the image data is transmitted to the displaying apparatus 24 (step S102).

In this case, when plural pages of data to be transmitted are present, the displaying portion 80 may be caused to display a list or thumbnails of the pieces of image data registered in the registration information DB, the user may select from the list or the thumbnails the image data that the user desires to transmit, and, thereafter, the confirmation button may also be pressed.

The input operation of the user is monitored and step S103 is repeated until the confirmation button is pressed (NO at step S103).

When the confirmation button is pressed (when a transmission instruction is issued) (YES at step S103), the image data selected and the identification information corresponding to the image data are transmitted from the displaying apparatus 24 to the image forming apparatus 22 (step S104).

Thereby, the displaying apparatus 24 has the image data and the identification information received stored in the image data storing portion 110.

Though the image data and the identification information are separately transferred from the image forming apparatus 22 to the displaying apparatus 24 in the above description, the identification information may be transferred being incorporated in the header of the image data.

In this case, because only one file is sufficient for the data to be transferred, the characteristic of the case is that its management is easy and this is effective for the case where the displaying apparatus 24 is unable to separately manage the identification information and the image data.

### <Printing Instruction Process of Image Data in General Control Portion of Displaying Apparatus 24>

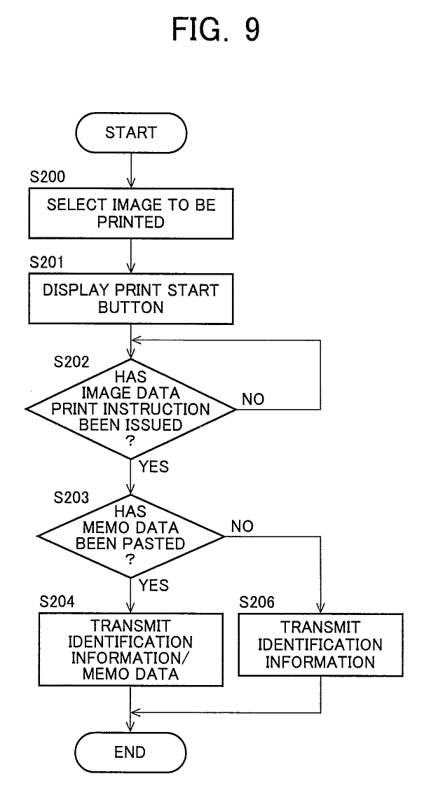

FIG. 9 is a flowchart of a process procedure to a step of transmitting printing instruction from the displaying apparatus 24 to the image forming apparatus 22. In this case, the procedure will be described taking an example of the case where the displaying apparatus 24 and the image forming apparatus 22 are connected with a USB cable and the image data displayed on the displaying apparatus 24 is printed.

The displaying apparatus 24 causes the user to select an image to be printed from the image being displayed and images stored in the image data storing portion 110 (step S200), and causes a print start button to be displayed to start printing the image selected (step S201).

The input operation of the user executed to the print start button is monitored, and step S202 is repeated until the print start button is pressed.

Whether memo data is added to the selected image data is determined by referring to the image data storing portion 110. When the memo data is added (YES at step S203), the displaying apparatus 24 transmits to the image forming apparatus 22 the identification information and the memo data that correspond to the selected image (step S204). In this case, the identification information includes information (yes) indicating that the memo data is added and position information (coordinates) indicating at what position of the image the memo data is added (combined).

On the other hand, when no memo data is added (NO at step S203), only the identification information of the selected image is transmitted (step S206). This identification information includes information (no) indicating that no memo data is added.

### <Printing Process in Apparatus Control Portion of Image Forming Apparatus 22>

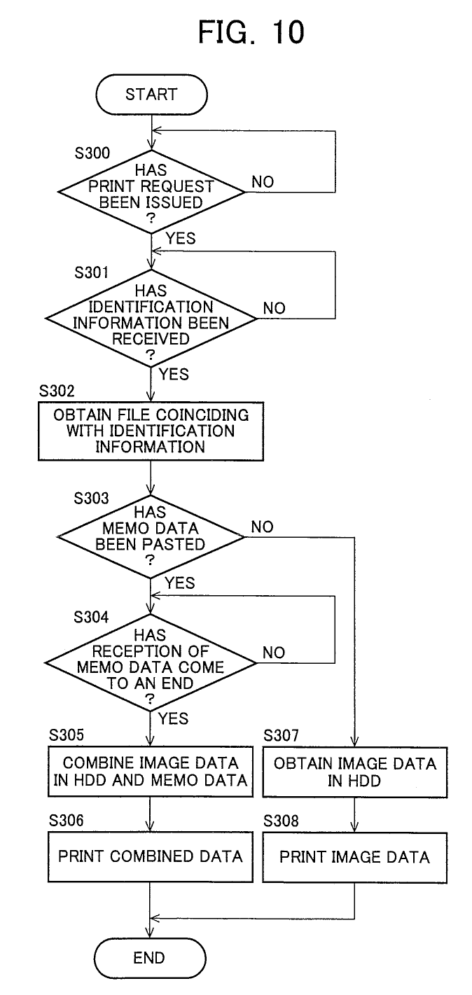

FIG. 10 is a flowchart of a process procedure to a step of printing of the image data for which a print request is issued, by the image forming apparatus 22.

Whether any print request is issued from the displaying apparatus 24 is determined, and step S300 is repeated until the print request is issued.

When a print request from the displaying apparatus 24 is received (YES at step S300), step S301 is repeated until the reception of the identification information is completed.

Image data corresponding to the identification information including the serial number and the information on the date and time that coincide with those in the received identification information is obtained by referring to the registration information DB (step S302).

When the presence or absence of the memo of the identification information received is “yes” (YES at step S303), step S304 is repeated until the reception of the memo data transmitted from the displaying apparatus 24 is completed.

The received memo data is synthesized with the image data read from the registration information DB by combining the memo data at the memo position of the identification information (step S305), and the combined pieces of data are printed (step S306).

On the other hand, when the presence or absence of the memo of the identification information received is “no” (NO at step S303), because no memo data needs to be pasted, image data corresponding to identification information including the serial number and the information on the date and time that coincide with those in the identification information received is read from the registration information DB (step S307), and the image data is printed (step S308).

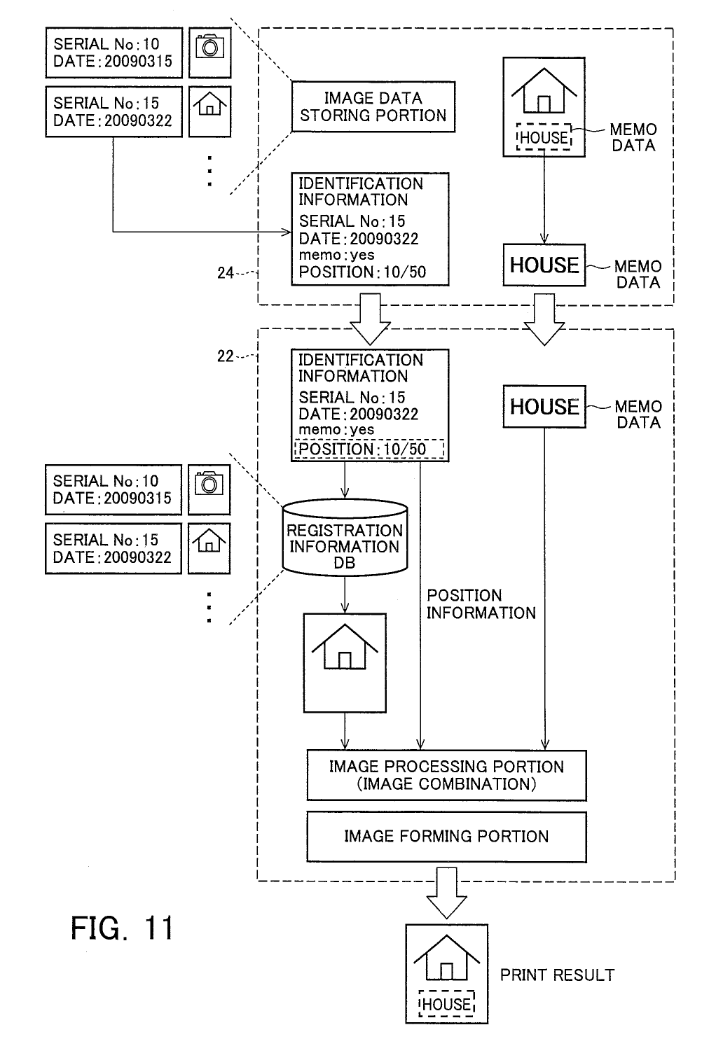

A printing procedure for image data and memo data displayed on the displaying apparatus 24 will be described with reference to FIG. 11.

The image data storing portion 110 of the displaying apparatus 24 has stored therein two pieces of image data (for an image of a camera and an image of a house) and two pieces of identification information, correlating the data and the information with each other. The displaying portion 106 of the displaying apparatus 24 displays thereon the image of the house and the memo data (HOUSE). The position (10/50) on the screen and the content (HOUSE) of the memo data are stored being correlated with the image of the house of the image data storing portion 110.

The registration information DB of the image forming apparatus 22 has stored therein the two pieces of image data (for the image of the camera and the image of the house) and the two pieces of identification information, correlating the data and the information with each other.

When a printing instruction for the image being displayed is issued from a user, the displaying apparatus 24 extracts an identification information that corresponds to the image being displayed from the image data storing portion 110. The displaying apparatus 24 transmits “the serial number of the image (15), information on the date and time (20090322), the presence or absence of the memo (yes), and the memo position (10/50)” as the identification information and the content of the memo data (HOUSE) to the image forming apparatus 22 through the USB I/F.

The image forming apparatus 22 extracts the serial number (15) and the information on the date and time (20090322) from the received identification information, and obtains the image data that correspond to the serial number and the information on date and time from the registration information DB.

The image forming apparatus 22 extracts the memo position (10/50) from the received identification information, combines the memo data (HOUSE) received by the image processing portion 58 with the image data at the memo position of the image data, and prints the resultant image data using the image forming portion 60.

Thereby, the memo data is synthesized with the image data displayed on the displaying apparatus 24 and the resultant image data is printed.

By adapting the embodiment to employ the above configuration, the image data captured by the image forming apparatus 22 in advance may be stored being attached with the identification information and, thereby, only transmitting the identification information from the displaying apparatus 24 enables printing of the image data displayed on the displaying apparatus 24 or the image data stored in the displaying apparatus 24. Thereby, an effect is achieved that the waiting time from the issuance of a print instruction to the completion of the printing may be reduced. Especially, when the image that the user desires to print is a color image or when an image having a large image size is printed, the amount of data transferred is large and, therefore, the present invention is effective.

Furthermore, when the memo data is added to the image data that the user desires to print from the displaying apparatus 24, only the position information of the memo data and the memo data are transmitted, and the image is synthesized when the image is printed. Thereby, the effect is also achieved that the waiting time from the issuance of a print instruction to the completion of the printing may be reduced.

### <Alterations>

The displaying apparatus 24 transmits only the identification information and the memo data in the above embodiment. However, the displaying apparatus 24 may transmit the identification information, the memo data, and also the image data.

This has an advantage that, the image data may be received during the search of the image registered in the registration information DB after the image forming apparatus 22 receives the identification information in this case, and, therefore, when the pieces of identification information do not coincide, the transfer time may be shorter than that for the transmission of the image data executed after the displaying apparatus 24 receives the notice of the search result.

When an image coinciding with the identification information is obtained as the result of the search, a notice representative of the presence of coincided data is transmitted and, thereby, the displaying apparatus 24 determines that the image data being transferred is unnecessary and may stop the transmission of the image data. Therefore, unnecessary transmission of data may be omitted and more efficient transmission and reception of data may be facilitated.

The registration information DB may be created automatically or by designation of the user depending on the communication speed of the interface connecting the image forming apparatus 22 and the displaying apparatus 24.

For example, when the interface is based on USB 1.1 whose communication speed is low, the image data may efficiently be printed by creating the registration information DB.

When the interface is based on USB 2.0 whose communication speed is high, the transfer time is reduced and, therefore, the present invention has an advantage that the management of the registration information DB and the identification information, etc. is made unnecessary by not creating the registration information DB for a small image size. Furthermore, because the image data is transferred from the displaying apparatus, the present invention has an advantage that the processing of the data is simplified.

The present invention is not limited to the above embodiment and various alterations and modifications may be made thereto without departing from the scope of the present invention.

According to the present invention, to transfer image data from the displaying apparatus to the image forming apparatus is unnecessary and, therefore, the waiting time from the issuance of a printing instruction to completion of the printing is reduced. Therefore, a printed matter may be quickly provided to a user.

1. An information displaying and printing system that comprises an image forming apparatus and a displaying apparatus connected to the image forming apparatus, wherein
the image forming apparatus comprises:
a registering portion that has an image data and an identification information of the image data stored in a registration information database correlating the image data and the identification information with each other;
a transmitting portion that transmits an image data and an identification information of the image data to the displaying apparatus;
a receiving portion that receives a print request of an image data from the displaying apparatus;
a searching portion that searches the registration information database in response to the print request; and
a printing portion that prints the image data of the search result, wherein
the displaying apparatus comprises:
a receiving portion that receives an image data and an identification information of the image data from the image forming apparatus;
a registering portion that has the image data and the identification information of the image data received stored in an image data storing portion; and
a transmitting portion that transmits the identification information for the image data to be printed, as a print request to the image forming apparatus, and wherein
when a print request is issued from the displaying apparatus, the image forming apparatus refers to the registration information database, searches for an identification information coinciding with the identification information received from the displaying apparatus, reads an image data corresponding to the identification information coinciding with the received identification information out of the registration information database, and prints the read image data.

2. The information displaying and printing system as defined in claim 1, wherein
the image data to be printed is an image data being displayed on the displaying apparatus or the image data stored in the image data storing portion.

3. The information displaying and printing system as defined in claim 1, wherein
the displaying apparatus further comprises a memo data adding portion for the image data stored in the image data storing portion and, when the memo data added to the image data is printed together with the image data, the displaying apparatus transmits the identification information of the image data, position information added with the memo data, and the memo data, and wherein
the image forming apparatus obtains an image data corresponding to the received identification information from the image information database, synthesizes the received memo data with the image data at the position indicated by the received position information, and prints the resultant image data.

4. The information displaying and printing system as defined in claim 1, wherein
when the image forming apparatus transmits the image data and the identification information to the displaying apparatus, the image forming apparatus transmits the image data and the identification information incorporating the identification information in the header portion of the image data.
